(19) United States
(12) Patent Application Publication
(10) Pub. No.: US 2025/0199588 A1
(43) Pub. Date: Jun. 19, 2025

(54) CASE FOR A TABLET SHAPED DEVICE

(71) Applicant: STM Management Pty Ltd, Alexandria NSW (AU)

(72) Inventor: Adina JACOBS, North Bondi NSW (AU)

(21) Appl. No.: 19/070,942

(22) Filed: Mar. 5, 2025

Related U.S. Application Data
(63) Continuation of application No. 18/980,540, filed on Dec. 13, 2024.

(30) Foreign Application Priority Data
Dec. 15, 2023 (AU) 2023904066

(51) Int. Cl. G06F 1/16

(52) U.S. Cl. CPC G06F 1/1656; G06F 1/1684

(57) ABSTRACT

The disclosure herein generally relates to a case for a tablet shaped device.

### CROSS-REFERENCE TO RELATED APPLICATIONS

The present application is a continuation of U.S. patent application Ser. No. 18/980,540, filed Dec. 13, 2024, which claims priority to Australian Provisional Application No. 2023904066, filed Dec. 15, 2023, the disclosures of which are hereby incorporated by reference in their entireties.

### TECHNICAL FIELD

The disclosure herein generally relates to a case for a tablet shaped device.

### BACKGROUND

Examples of tablet shaped devices include but are not limited to a tablet computer, an APPLE IPAD PRO™, SAMSUNG GALAXY TAB™, and AMAZON FIRE™. Tablet shaped devices may have at least one port for connection to external devices and charging.

Some tablet shaped devices have only one port. For example, the current APPLE IPAD™ and SAMSUNG GALAXY TAB™ each have a single USB-C port. Consequently, a charger plug connector and a headphone plug connector cannot by simultaneously received by these tablet shaped devices. Similarly, an external microphone plug connector and a keyboard plug connector cannot be simultaneously received. It may be desired, however, to simultaneously use multiple connectorized devices with a tablet shaped device with only one port.

Furthermore, it may be desired to extend the functionality of a tablet shaped device by connecting a peripheral to the port. Port connectors, however, are generally not sufficiently robust for day-to-day use, especially but not exclusively when the tablet shaped device is used in the field, an industrial environment. or a military environment, for example. Knocks and the like can break the connector, or disconnect the peripheral from the tablet shaped device.

### SUMMARY

Disclosed herein is a case for a tablet shaped device. The device comprises a peripheral device comprising an inwardly orientated connector for connecting to a port of the tablet shaped device.

In an embodiment, the peripheral device is at the perimeter of the case.

An embodiment comprises a perimeter wall configured to receive the tablet shaped device therein and defining a tablet shaped device receiving interior.

In an embodiment, the peripheral device is movably mounted to the perimeter wall. The peripheral device may be slidably mounted to the perimeter wall. The perimeter wall may define a peripheral device receiving cavity in which the peripheral device is received. The perimeter wall may define at least one slot and the peripheral device comprises at least one slot insert disposed therein. The at least one slot insert may be slidingly captured within the at least one slot. The perimeter wall may comprise a plurality of sliding limit stops for the at least one slot insert.

In an embodiment, the peripheral device comprises a plurality of outwardly orientated connectors in communication with the inwardly orientated connector.

In an embodiment, the inwardly orientated connector comprises a USB connector. The plurality of outwardly orientated connectors may comprise a USB connector. The plurality of outwardly orientated connectors may comprise a headphone jack.

In an embodiment, the peripheral device comprises a port expander.

In an embodiment, the peripheral device comprises a Radio Frequency Identification (RFID) reader.

In an embodiment, the peripheral device comprises a tracking device.

In an embodiment, the peripheral device comprises a scanner.

In an embodiment, the peripheral device comprises a housing. Electronics may be disposed within the housing.

Disclosed herein is a method for connecting a peripheral device to a tablet shaped device, the method comprising. The method comprises moving a peripheral device of a case for a tablet shaped device outwardly. The method comprises receiving the tablet shaped device within the case. The method comprises moving the peripheral device inwardly such that a connector of the peripheral device connects with a connector of the tablet shaped device.

In an embodiment, the peripheral device comprises a port expander. The peripheral device may take any suitable and desired form, for example a location tracker, a RFID reader and an optical scanner.

The case may be in accordance with the above disclosure.

Any of the various features of each of the above disclosures, and of the various features of the embodiments described below, can be combined as suitable and desired.

### BRIEF DESCRIPTION OF THE DRAWINGS

Embodiments will now be described by way of example only with reference to the accompanying figures in which:

FIG. 1 shows an isometric view of an embodiment of a case for a tablet shaped device receiving an example tablet shaped device.

FIG. 2 shows an isometric view of the case of FIG. 1 with the tablet shaped device received thereby.

FIG. 3 shows a bottom view of a peripheral in the form of a port expander of the case isolated from the case of FIG. 1.

FIG. 4 shows a side elevation view of the port expander.

FIGS. 5 and 6 show different isometric views of the port expander.

FIG. 7 shows an end view of the port expander.

FIG. 8 shows a plan view of the port expander.

FIG. 9 shows an isometric view of the port expander with a closure thereof removed to reveal a printed circuit board mounted within the port expander.

FIG. 10 shows an isometric view of the printed circuit board of the port expander.

FIG. 11 shows a plan view of the case.

FIG. 12 shows an isometric interior view of the end of the case that has the port expander.

FIGS. 13 to 16 show various views of an end of the case that comprises the port expander.

FIGS. 17 and 18 each show a close up of the end of the case of FIGS. 13 to 17, with the port expander hidden to reveal a port expander receiving cavity.

FIG. 19 shows an isometric close-up view of the port expander showing sliding attachment thereof to a perimeter frame of the case.

FIG. 20 shows a flow chart of an embodiment of a method for connecting a peripheral device to a tablet shaped device.

### DESCRIPTION OF EMBODIMENTS

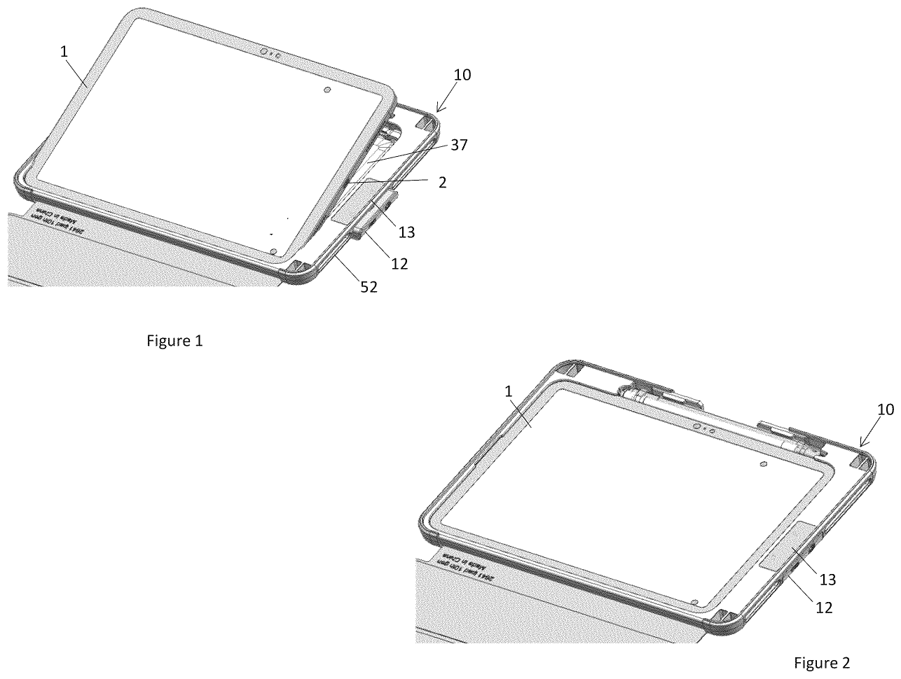

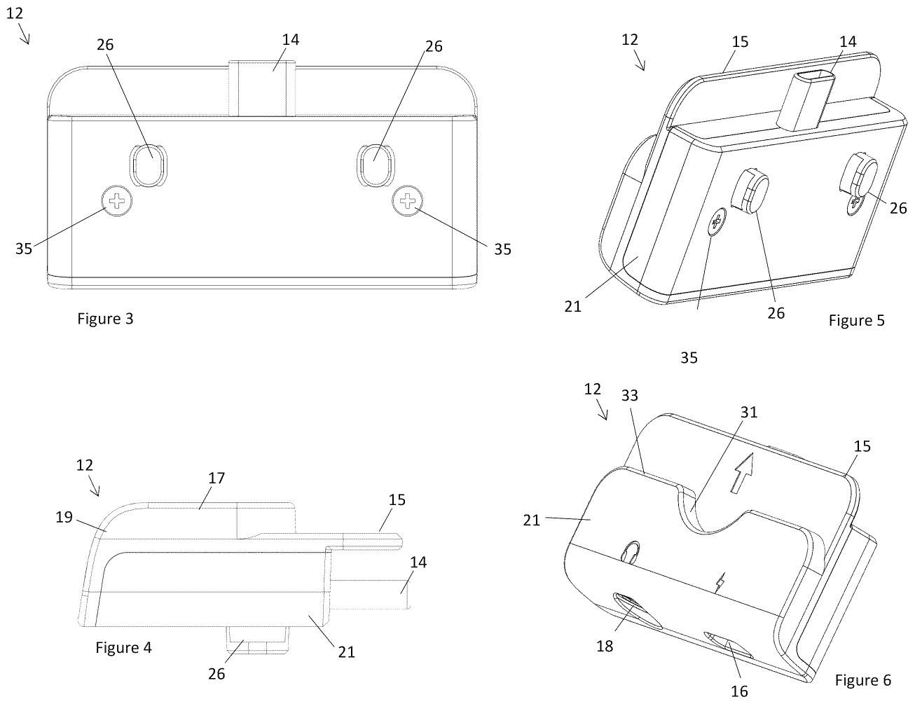

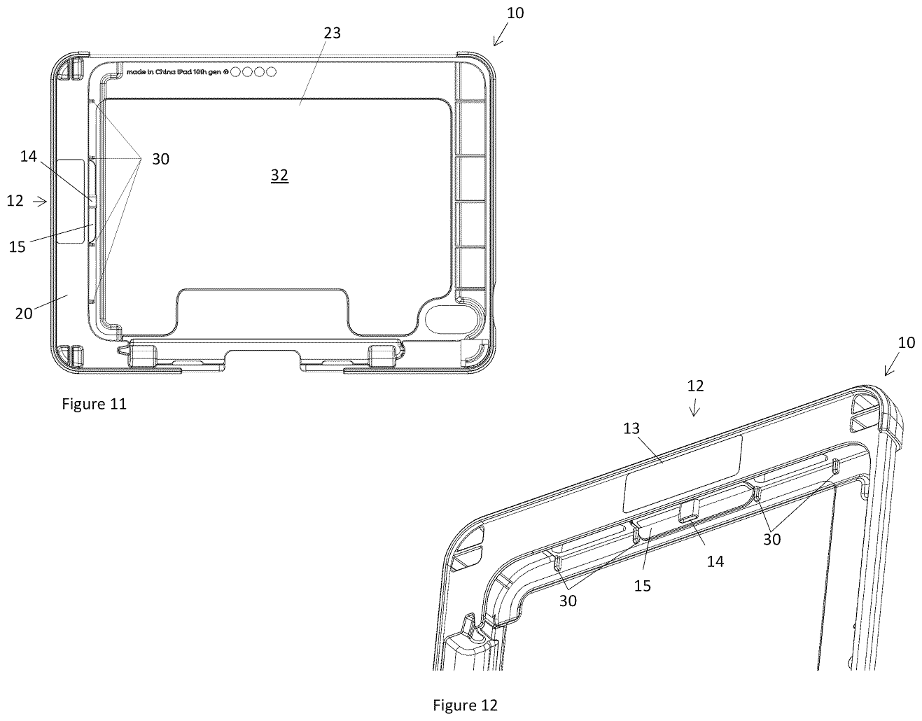

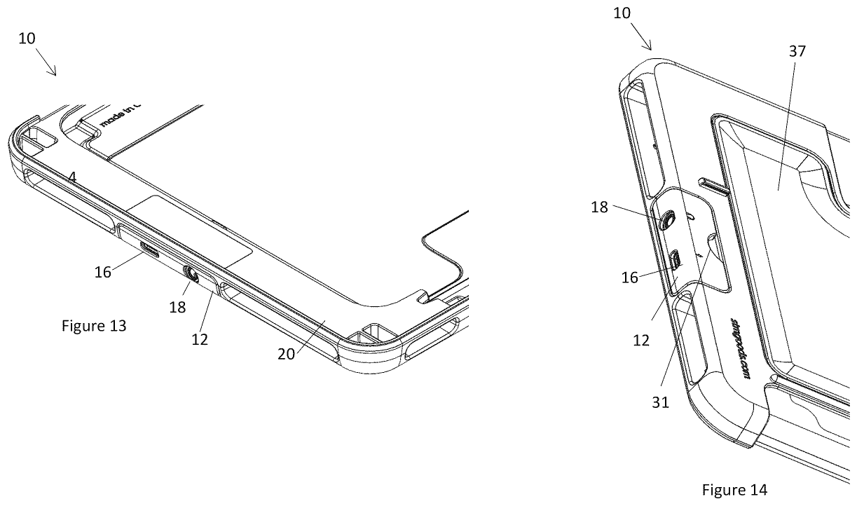

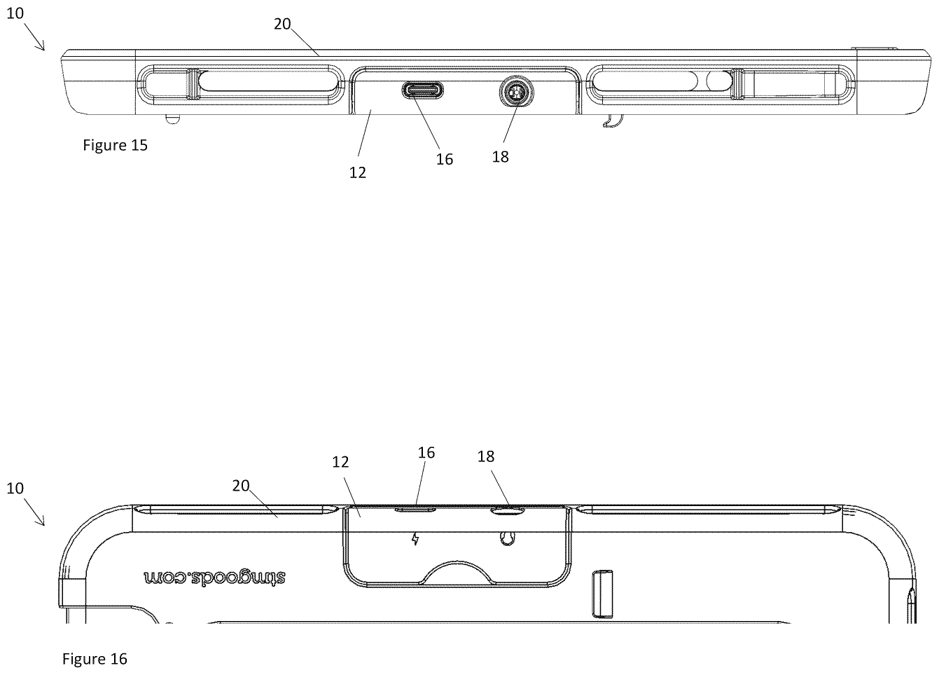

FIG. 1 is an isometric view showing a tablet shaped device (“tablet”) in the form of an APPLE IPAD being received by an embodiment of a case for a tablet shaped device (“case”), respectively generally indicated by the numerals 1 and 10. FIG. 2 shows an isometric view showing the tablet 1 received by the case 10. The tablet 1 has a connector socket 2 in the form of a USB type-C connector socket. The case 10 comprises a peripheral device 12 in the form of a port expander. FIGS. 3 to 8 shows various views of the port expander 12 with the rest of the case 1 hidden. The port expander 12 comprises an inwardly orientated connector 14 in the form of a USB type-C plug for connecting to the connector socket 2 of the tablet shaped device 1. The port expander 12 comprises a plurality of outwardly orientated connectors 16, 18 in communication with the inwardly orientated connector 14. Connector 16 is in the form of a USB Type-C socket connector in electrical power communication with connector 14 for charging the tablet 1 via connector 14, and the connector 18 is in the form of a 3.5 mm headphone jack for audio electrical signal communication with connector 14, for connecting headphones and/or a microphone to the tablet 1 via connector 14. The connectors 16,18 may generally have any suitable and desired form for any suitable and desired form of electrical and/or signal communication. The peripheral device 12 comprises a housing 21 in the form of a housing assembly that protects the contents thereof. The housing assembly 21 is fixed together with at least one fastener in the form of a screw 35. Removing the at least one fastener 35 enables disassembly of the housing assembly 21, as shown in FIG. 9, which shows electronics in the form of a printed circuit board (PCB) housed in the housing 21 and to which are attached PCB mount connectors 14,16,18. The housing 21 defines a connector aperture for each of the connectors 14,16,18. As seen in FIG. 11, for example, the case 10 comprises a perimeter wall 20. The peripheral device 12 is mounted to the perimeter wall 20 and is housed at least in part therein. As understood with reference to FIGS. 1 and 2, for example, the peripheral device 12 is movably mounted to the perimeter wall 20. In FIG. 1, the peripheral device 12 is extended, and in FIG. 2 the peripheral device 12 is retracted. The peripheral device 12 can be moved with a sliding motion between the extended position shown in FIG. 1 and the retracted position shown in FIG. 2. Peripheral device 12 has a handle 31 defined by an arcuate cut-out or rebate at inwardly orientated surface 33. The handle 31 is at the outside of the back face 37. Peripheral device 12 also comprises an interiorly directed tongue 15 and outer curved surface 19 in keeping with the curved outer surface of the perimeter wall 20. A user can engage handle 31, for example with a finger-tip, to move the peripheral device 12.

The perimeter wall 20 defines a device receiving interior space 23 that generally has a complementary configuration to the tablet 1. The interior space 23 is backed by back wall 37 comprising inwardly orientated face 32 that is generally orientated to the tablet 1 when received and so the user. The perimeter wall 20 is configured to engagingly receive the tablet 1 within the interior space 23. The perimeter wall 20 comprises a resilient material, such as an elastomer, to enable resilient engagement with the tablet 1. The tablet 1 is received by a plurality of risers 30 in the form of riser tabs that separate the tablet 1 from the inside face 32 of the case 1. Tongue 15 extends into the interior space 23 beneath the tablet shaped device 1 when received. The tongue is intermediate two riser tabs 20.

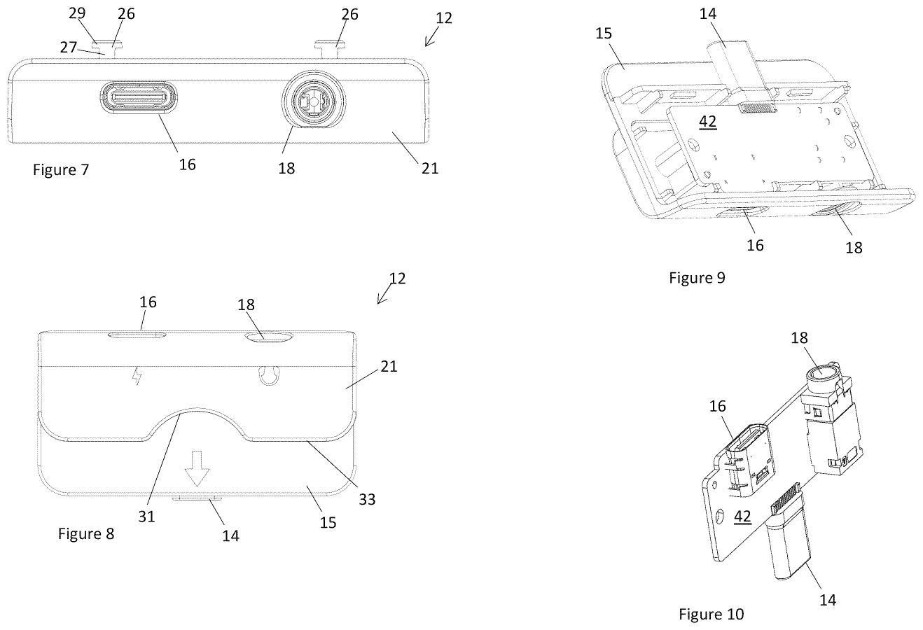

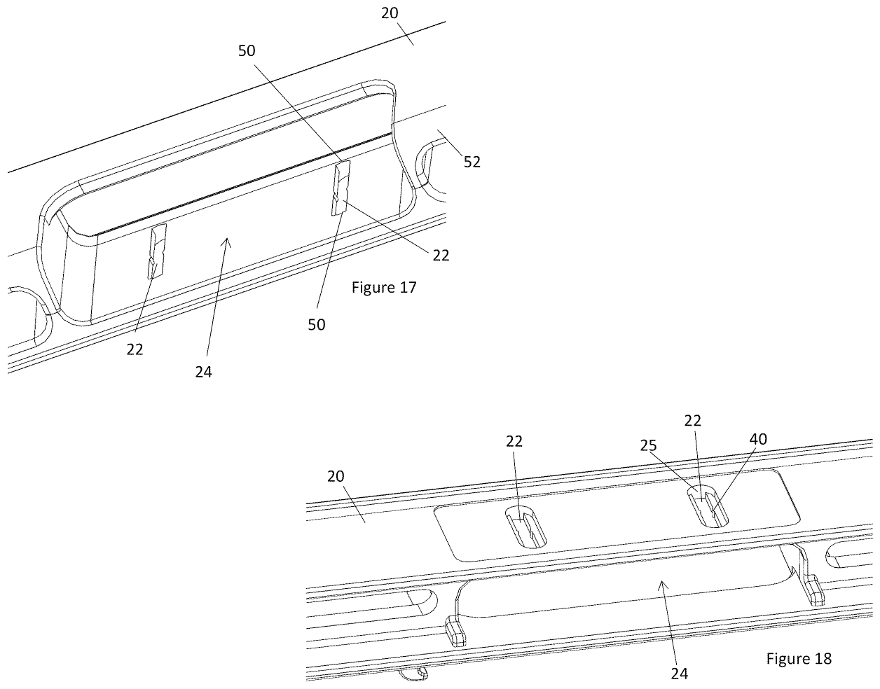

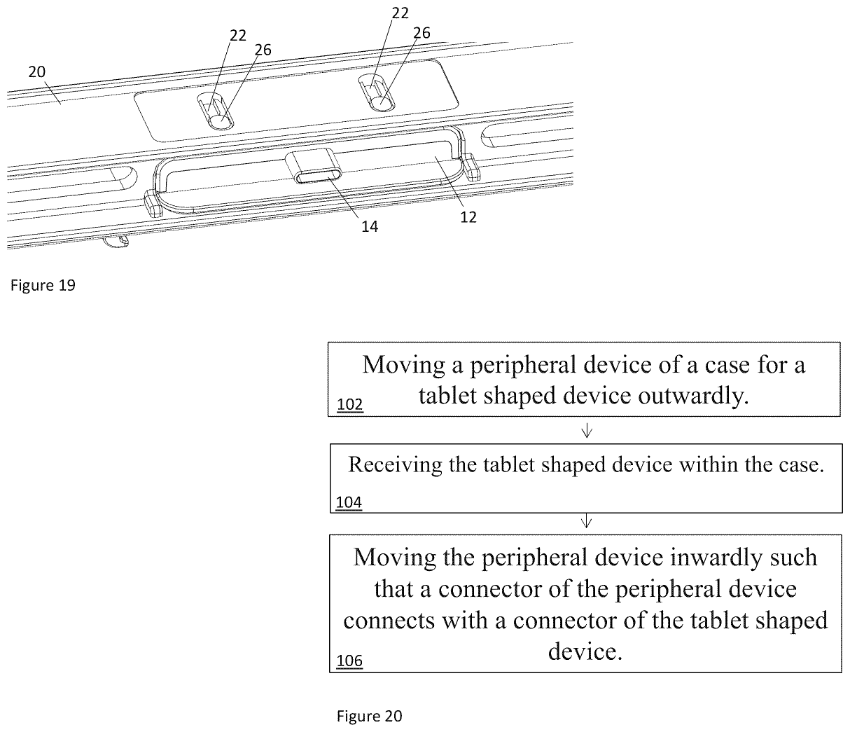

To facilitate extension and retraction, the peripheral device 12 is slidably mounted to the perimeter wall 20. As seen in FIGS. 17 and 18, for example, the edge of the perimeter wall 20 defines a peripheral device receiving cavity 24 in the form of a peripheral device receiving aperture (elongated passageway or tunnel) that has outside opening (at an outer edge of the perimeter wall) and inside opening (at an inside edge of the perimeter wall). The device receiving cavity extends a minor portion of a side 52 of the perimeter wall 20. The perimeter wall defines at least one aperture 22, which in this embodiment are in the form of a plurality of slots 22. The plurality of slots 22 each have a longitudinal axis that is outwardly directed, the sidewalls of which act as linear motion guides. The at least one aperture is hidden behind a closure 13 which has been removed in FIG. 18. The aperture 22 may, however, generally take any suitable and desired form. The closure 13 and apertures 22 are on opposite sides of the case 10 to the back wall 37. The peripheral device 12 comprises at least one sliding slot insert 26 in the form of least one sliding anchor disposed in the at least one outwardly directed slot 22. In this but not necessarily all embodiments, the slot inserts 26 are captured within the slots 22. With reference to FIG. 7, the sliding anchor 26 comprises a body 27 in the form of a tab that is generally rectangular and a distal cap 29 attached to the body 27, the distal cap 29 being countersunk and disposed within another slot 25 defined by the perimeter wall 20 that is at slot 22's exterior side and wider than slot 22. The tab 27 is received within one of the apertures 22 and the cap 29 is configured to assist preventing the sliding anchor from being pulled through aperture 22 and consequently separation of the peripheral device 12 from the perimeter wall 20. Consequently, in this but not all embodiments the peripheral device 12 is inseparably mounted. The sliding anchor can generally take any suitable and desired form, for example the body 27 may take the form of a shaft. The sliding range of the sliding anchor is defined by the perimeter wall which is arranged therefore. The perimeter wall 20 can interfere with the sliding anchor 29 to stop its motion and so defines sliding limit stops 50 at the end of each of the slots 22. Protruding into slot 22 and intermediate the ends thereof are resilient stops 40 that are resiliently deformed by passage of the sliding anchors 26 therepast, and which can inwardly retain the sliding anchor. This may assist in the unwanted separation of the connector 14 from the device 1 and provide haptic feedback to the user.

The peripheral device 12 comprises generally any suitable electronics in communication with the ports. For example, in the present embodiment mounted to the PCB is a USB-C DAC integrated circuit (AL4042, for example) in signal communication with the inwardly directed plug connector 14, and which takes a digital audio signal from connector 14 and converts it into an analogue signal that is received by an amplifier integrated circuit (INA1620, for example) mounted to the PCB. The output of the amplifier is in signal communication with the headphone jack 18. Alternatively, the output of the DAC can be directly communicated to the headphone jack. The one or more integrated circuits may be powered by power drawn from the VBUS and GND pins of one of the USB ports. VBUS and GND pins of the USB Type-C ports 14,16 may be wired together to enable charging.

In alternative embodiments, the peripheral device 12 has alternative or additional functionality. For example:
In an embodiment, the peripheral device 12 comprises a Radio Frequency Identification (RFID) reader in communication with the inwardly directed connector 14. The RFID reader may comprise, for example, a Texas Instruments TRF7964ARHBR IC RFID Reader operating at 13.56 MHZ mounted to the printed circuit board together with supporting electronics, or generally any suitable RFID integrated circuit. A user's credential information can be read information from a RFID card and software on the tablet shaped device can use the read credential information to control access to the tablet shaped device.
In an embodiment, the peripheral device 12 comprises a location tracking device and/or a location tracking tag. This may, for example, provide location tracking in hazardous areas, for example heavy industrial sites.
In an embodiment, the peripheral device comprises an optical scanner (for example a bar code or QR code optical scanner) in communication with the inwardly directed connector. The optical scanner can be used in a warehouse, for example. A user may be able to scan a code on a package and information on the package may be subsequently displayed on the tablet shaped device 1.
In an embodiment, the peripheral device 12 comprises an alternative audio interface in communication with the inwardly directed connector 14. The audio interface may comprise a microphone port, an electric guitar port or generally any suitable and desired audio signal port. The audio interface may be used by a musician to, for example, record live music on the tablet shaped device.

Steps of an embodiment of a method for connecting a peripheral device—for example the port expander 12, a RFID reader, a location tracking device, or an optical scanner—to the tablet 1 will now be described with reference to the figures and in particular the flow chart of FIG. 20. A step 102 comprises moving the peripheral device 12 outwardly. A step 104 comprises receiving device 1 within the case 10. A step 106 comprises moving the peripheral device 12 inwardly such that connector 14 of the peripheral device 12 connects with the connector 2 of the tablet.

Now that embodiments have been described, it will be appreciated that some embodiments may have some of the following advantages:
Peripheral devices may be connected to the tablet shaped device to extend its functionality.
The peripheral device may be protected by the case.
The connection between the peripheral and the tablet shaped device may be more robust and the connector less likely to be broken.
The number of ports available may be increased.
The peripheral device may not fall out or trivially separated, and subsequently lost.
Improved aesthetics.

Variations and/or modifications may be made to the embodiments described without departing from the spirit or ambit of the invention. For example:
The USB type-C connectors of the tablet and case may generally be any suitable type of connector, for example USB standard A, USB standard B, USB micro, USB mini, Thunderbolt, and a 2.5 mm or 3.5 mm headphone connector.
The peripheral device may only have ports of the one standard, for example a USB Type-C plug connector and two USB Type-C socket connectors in signal communication with the plug connector.
The peripheral device may have more than two socket connectors in signal communication with the plug connector, for example a HDMI socket, a USB standard A socket, an RJ45 ethernet connector, a charger connector, and a headphone jack. Generally, any suitable and desired combination and number of sockets types may be used.
While the illustrated port expander comprises a USB hub, the port expander may generally be any suitable and desired type, examples of which include a hub, a splitter and a switch.
Sockets may be switched to ports and vice versa as suitable and desired.
The housing may not be an assembly and may be indivisible.
Other examples of tablet shaped devices may alternatively or additionally comprise a connector plug. An alternative embodiment may have an inwardly directed socket for tablets with a connector plug.
The risers tabs may generally take any suitable and desired alternative form, for example riser posts and riser ribs.
The peripheral device may be free to be removed.

The present embodiments are, therefore, to be considered in all respects as illustrative and not restrictive. Reference to a feature disclosed herein does not mean that all embodiments must include the feature.

Prior art, if any, described herein is not to be taken as an admission that the prior art forms part of the common general knowledge in any jurisdiction.

In the claims which follow and in the preceding description of the invention, except where the context requires otherwise due to express language or necessary implication, the word “comprise” or variations such as “comprises” or “comprising” is used in an inclusive sense, that is to specify the presence of the stated features but not to preclude the presence or addition of further features in various embodiments of the invention.

1. A case for a tablet shaped device comprising:
a perimeter wall configured to receive the tablet shaped device therein and defining a tablet shaped device receiving interior;
a peripheral device at the perimeter wall and relatively movable thereto, the peripheral device comprising:
an inwardly orientated USB plug connector for connecting to a port of the tablet shaped device; and
an outwardly orientated USB socket connector and an outwardly orientated headphone jack each open to an exterior and in communication with the inwardly orientated connector for simultaneous use of the outwardly oriented connectors.

2. The case defined by claim 1, wherein the peripheral device is movably mounted to the perimeter wall.

3. The case defined by claim 1, wherein the peripheral device is slidably mounted to the perimeter wall.

4. The case defined by claim 1, wherein the perimeter wall defines a peripheral device receiving cavity in which the peripheral device is received.

5. The case defined by claim 4, wherein the perimeter wall defines at least one slot and the peripheral device comprises at least one slot insert disposed therein.

6. The case defined by claim 5, wherein the at least one slot insert is slidingly captured within the at least one slot.

7. The case defined by claim 6, wherein the perimeter wall comprises a plurality of sliding limit stops for the at least one slot insert.

8. The case defined by claim 1, wherein the peripheral device comprises a port expander.

9. The case defined by claim 1, wherein the peripheral device comprises a housing.

10. The case defined by claim 9, further comprising electronics disposed within the housing.

11. The case defined by claim 1, further comprising a stylus holder, where the stylus holder is at an edge of the case and the peripheral device is at another edge of the case that is shorter than the edge.

12. The case defined by claim 1, further comprising a screen protection member for protecting the screen of the tablet shaped device when so received.

13. The case defined by claim 1, further comprising a web within at least one corner of the perimeter wall.

14. The case defined by claim 1, wherein the peripheral device comprises a housing in which is housed electronics in communication with the inwardly orientated USB plug connector, the outwardly orientated USB socket connector and the outwardly orientated headphone jack.

15. The case defined by claim 14, wherein the electronics comprises a DAC integrated circuit.

16. The case defined by claim 14, wherein the electronics comprises an amplifier integrated circuit.

17. The case defined by claim 14, wherein the electronics is powered via at least one of the inwardly orientated USB plug connector and the outwardly orientated USB socket connector.

18. A method for protecting a tablet shaped device, the method comprising:
disposing a tablet shaped device in a case for the tablet shaped device, the case comprising:
a perimeter wall configured to receive the tablet shaped device therein and defining a tablet shaped device receiving interior;
a peripheral device at the perimeter wall and relatively movable thereto, the peripheral device comprising:
an inwardly orientated USB plug connector for connecting to a port of the tablet shaped device; and
an outwardly orientated USB socket connector and an outwardly orientated headphone jack each open to an exterior and in communication with the inwardly orientated connector for simultaneous use of the outwardly oriented connectors; and
connecting the inwardly orientated USB plug connector to the port of the tablet shaped device.

19. The method defined by claim 18, further comprising disposing a screen protection member of the case over the screen of the tablet shaped device.

20. The method defined by claim 18, wherein the peripheral device comprises electronics, and comprising the step of powering the electronics via at least one of the inwardly orientated USB plug connector and the outwardly orientated USB socket.
